(19) United States
(12) Patent Application Publication
(10) Pub. No.: US 2014/0085390 A1
(43) Pub. Date: Mar. 27, 2014

(54) VACUUM PULLDOWN OF WEB IN PRINTING SYSTEMS

(71) Applicants: TIMOTHY J. YOUNG, WILLIAMSON, NY (US); MICHAEL J. PIATT, DAYTON, OH (US); HARSHA S. BULATHSINGHALAGE, MIAMISBURG, OH (US); RANDY D. VANDAGRIFF, XENIA, OH (US); W. C. KASISKE, JR., WEBSTER, NY (US)

(72) Inventors: TIMOTHY J. YOUNG, WILLIAMSON, NY (US); MICHAEL J. PIATT, DAYTON, OH (US); HARSHA S. BULATHSINGHALAGE, MIAMISBURG, OH (US); RANDY D. VANDAGRIFF, XENIA, OH (US); W. C. KASISKE, JR., WEBSTER, NY (US)

(21) Appl. No.: 14/016,486

(22) Filed: Sep. 3, 2013

Related U.S. Application Data
(60) Provisional application No. 61/706,185, filed on Sep. 27, 2012.

(51) Int. Cl. B41J 11/00

(52) U.S. Cl. CPC B41J 11/0085
USPC 347/104

(57) ABSTRACT

According to the present invention, a printing system adapted to print on a print side of a print media is disclosed. The printing system comprises one or more vacuum assemblies. Each vacuum assembly has a vacuum manifold disposed opposite a non-print side of the print media. Each vacuum manifold has an opening proximate to the non-print side of the print media and produces a vacuum that pulls the print media towards the vacuum manifold as the print media is moved through the printing system. The vacuum manifold further includes a plurality of edge seals. Each of the edge seals includes a channel for vacuum to be applied to the non-print side of the print media, the channel having at least one opening formed in a print media contact surface of the edge seal connected to at least one opening formed in a side surface of the edge seal.

### CROSS REFERENCE TO RELATED APPLICATIONS

This application claims priority from Provisional Application Ser. No. 61/706,185 filed Sep. 27, 2012.

### TECHNICAL FIELD

The present invention generally relates to printing systems and more particularly to the use of vacuum to pull down the edges of a web in the printing system.

### BACKGROUND

In a digitally controlled printing system, such as an inkjet printing system, a print media is directed through a series of components. The print media can be a cut sheet or a continuous web. A web or cut sheet transport system physically moves the print media through the printing system. As the print media moves through the printing system, liquid, for example, ink, is applied to the first side of the print media by one or more printheads through a process commonly referred to a jetting of the liquid. The jetting of liquid onto the print media introduces significant moisture content to the print media, particularly when the system is used to print multiple colors on a print media. Due to its moisture content, the print media expands and contracts in a non-isotropic manner often with significant hysteresis. The continual change of dimensional characteristics of the print media often adversely affects image quality. Although drying is used to remove moisture from the print media, drying too frequently, for example, after printing each color, also causes changes in the dimensional characteristics of the print media that often adversely affects image quality.

FIG. 1 illustrates a portion of the print media as the print media passes over two rollers that support the print media under each row of printheads in accordance with the prior art. During an inkjet printing process, the print media can expand as the print media absorbs the water-based inks applied to it. When the direction of expansion is in a direction that is perpendicular to the direction of media travel 100, it is often referred to as expansion in the crosstrack direction 102. Typically, the wrap of the print media around a roller of an inkjet printing system produces sufficient friction between the print media and the roller that the print media is not free to slide in the crosstrack direction even though the print media is expanding in that direction. This can result in localized buckling of the print media away from the roller to create lengthwise ripples, also called flutes or wrinkles, in the print media. Flutes or ridges 104, 106 can be produced in the print media due to expansion of the print media in the crosstrack direction 102 because the print media cannot slip on the rollers 108, 110. Wrinkling of the print media during the printing process often leads to permanent creases forming in the print media that ultimately affect image quality.

Multiple printheads are typically located and aligned by a support structure to form a linehead, with the linehead located over the print media. In many such systems, the support structure of the linehead locates the printheads in two or more rows; the rows positioned parallel to each other and aligned in the crosstrack direction. To prevent the print media from fluttering, or vibrating up and down in the print zone, the print media is supported by a roller that is aligned with the print line of each row of printheads. It is not uncommon for the bottom face of the support structure to become wet, either due to condensation from the moist air produced by the printing process or due to mist drops created by the print drops striking the print media.

It has been found that under some printing conditions the flutes in the print media can be sufficiently tall that top of the flutes can contact the bottom face of the support structure. When this occurs, the moist ink on the flutes can be smeared by the contact. Additionally, the moisture on the bottom of the support structure can be transferred to the print media. The result is a degradation of the print quality.

There remains a need to better manage the vacuum, provided by the vacuum assembly, near the edges of the print media.

### SUMMARY OF THE INVENTION

In one aspect according to the present invention, a printing system adapted to print on a print side of a print media comprises one or more vacuum assemblies, each vacuum assembly having a vacuum manifold disposed opposite a non-print side of the print media, each vacuum manifold having an opening proximate to the non-print side of the print media and produces a vacuum that pulls the print media towards the vacuum manifold as the print media is moved through the printing system, and, each vacuum manifold further including a plurality of edge seals, wherein each of the plurality of edge seals includes a channel for vacuum to be applied to the non-print side of the print media, the channel having at least one opening formed in a print media contact surface of the edge seal and at least one opening formed in a side surface of the edge seal and wherein the at least two openings are connected.

The vibration of the edges of the print media can adversely affect the quality of the images printed on the print media, use of the edge seals can improve print quality. Reducing the air leakage around the edges of the print media using the present invention lowers the flow rate requirements of the vacuum source, which can lower the cost of the vacuum source. The reduced air leakage around the edges of the print media also helps to ensure a more uniform vacuum level all the way to the edges of the print media. This provides a more uniform deflection of the print media toward the vacuum manifold across the width of the vacuum manifold.

### BRIEF DESCRIPTION OF THE DRAWINGS

Aspects of the invention are better understood with reference to the following drawings. The elements of the drawings are not necessarily to scale relative to each other.

FIG. 1 illustrates a portion of the print media as the print media passes over two rollers that support the print media under each row of printheads in accordance with the prior art;

FIG. 2 is a schematic side view of one example of an inkjet printing system that prints on a continuous web of print media;

FIG. 3 is a schematic side view of an example of a first printing system according to an aspect of the invention;

FIG. 4 is a more detailed side view of a portion of the first printing system shown in FIG. 3;

FIG. 5 is a perspective view of an example of an edge seal 304 in an according to an aspect of the invention;

FIG. 6 is another perspective view of the edge seal 304 shown in FIG. 5;

FIGS. 7-8 illustrate an example of the rollers 212, sealing rollers 300, guide surfaces 302, and edge seals 304 according to an aspect of the invention;

FIG. 9 depicts a schematic side view of a second printing system that includes a vacuum assembly according to an aspect of the invention; and

FIG. 10 is a more detailed side view of a portion of the second printing system shown in FIG. 9.

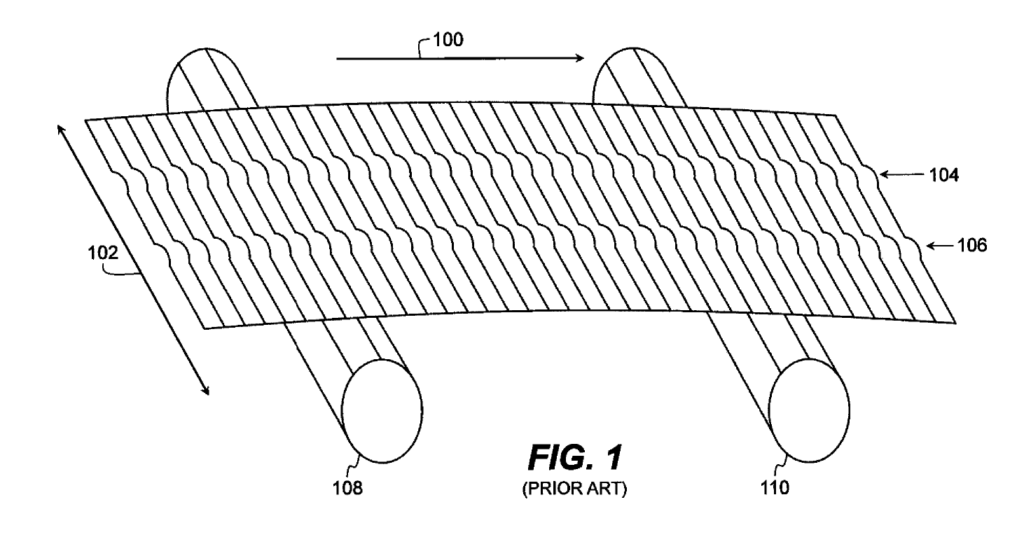

### DETAILED DESCRIPTION OF THE INVENTION

Throughout the specification, the following terms take the meanings explicitly associated herein, unless the context clearly dictates otherwise. The meaning of “a,” “an,” and “the” includes plural reference, the meaning of “in” includes “in” and “on.”. Additionally, directional terms such as “on”, “over”, “top”, “bottom”, “left”, “right” are used with reference to the orientation of the Figure(s) described. Because components of aspects of the present invention can be positioned in a number of different orientations, the directional terminology is used for purposes of illustration only and is in no way limiting.

The present description will be directed in particular to elements forming part of, or cooperating more directly with, an apparatus in accordance with the present invention. It is to be understood that elements not specifically shown, labeled, or described can take various forms well known to those skilled in the art. In the following description and drawings, identical reference numerals have been used, where possible, to designate identical elements. It is to be understood that elements and components can be referred to in singular or plural form, as appropriate, without limiting the scope of the invention.

The example aspects of the present invention are illustrated schematically and not to scale for the sake of clarity. One of ordinary skill in the art will be able to readily determine the specific size and interconnections of the elements of the example aspects of the present invention.

As described herein, the example aspects of the present invention can be used in printing systems, including inkjet printing systems that include a printhead or printhead components. Many applications are emerging which use inkjet printheads to emit liquids (other than inks) that need to be finely metered and deposited with high spatial precision. Such liquids include inks, both water based and solvent based, that include one or more dyes or pigments. These liquids also include various substrate coatings and treatments, various medicinal materials, and functional materials useful for forming, for example, various circuitry components or structural components. As such, as described herein, the terms “liquid” and “ink” refer to any material that is ejected by the printhead or printhead components described below.

Inkjet printing is commonly used for printing on paper. However, there are numerous other materials in which inkjet is appropriate. For example, vinyl sheets, plastic sheets, textiles, paperboard, and corrugated cardboard can comprise the print media. Additionally, although the term inkjet is often used to describe the printing process, the term jetting is also appropriate wherever ink or other liquids is applied in a consistent, metered fashion, particularly if the desired result is a thin layer or coating.

Inkjet printing is a non-contact application of an ink to a print media. Typically, one of two types of ink jetting mechanisms are used and are categorized by technology as either drop on demand ink jet (DOD) or continuous ink jet (CIJ). The first technology, “drop-on-demand” (DOD) ink jet printing, provides ink drops that impact upon a recording surface using a pressurization actuator, for example, a thermal, piezoelectric, or electrostatic actuator. One commonly practiced drop-on-demand technology uses thermal actuation to eject ink drops from a nozzle. A heater, located at or near the nozzle, heats the ink sufficiently to boil, forming a vapor bubble that creates enough internal pressure to eject an ink drop. This form of inkjet is commonly termed “thermal ink jet (TIJ).”

The second technology commonly referred to as “continuous” ink jet (CIJ) printing, uses a pressurized ink source to produce a continuous liquid jet stream of ink by forcing ink, under pressure, through a nozzle. The stream of ink is perturbed using a drop forming mechanism such that the liquid jet breaks up into drops of ink in a predictable manner. One continuous printing technology uses thermal stimulation of the liquid jet with a heater to form drops that eventually become print drops and non-print drops. Printing occurs by selectively deflecting one of the print drops and the non-print drops and catching the non-print drops. Various approaches for selectively deflecting drops have been developed including electrostatic deflection, air deflection, and thermal deflection.

Additionally, there are typically two types of print media used with inkjet printing systems. The first type is commonly referred to as a continuous web while the second type is commonly referred to as a cut sheet(s). The continuous web of print media refers to a continuous strip of media, generally originating from a source roll. The continuous web of print media is moved relative to the inkjet printing system components via a web transport system, which typically include drive rollers, web guide rollers, and web tension sensors. Cut sheets refer to individual sheets of print media that are moved relative to the inkjet printing system components via rollers and drive wheels or via a conveyor belt system that is routed through the inkjet printing system. The print media has a print side adapted to receive liquid or ink from a linehead, and a non-print side.

The invention described herein is applicable to both types of printing technologies. As such, the terms printhead and linehead, as used herein, are intended to be generic and not specific to either technology. Additionally, the invention described herein is applicable to both types of print media. As such, the terms web and print media, as used herein, are intended to be generic and not as specific to either type of print media or the way in which the print media is moved through the printing system.

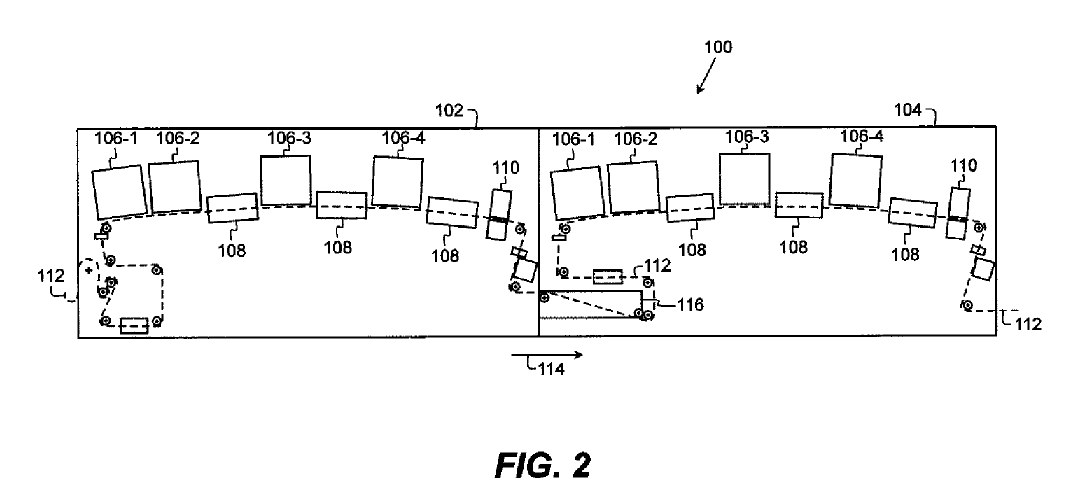

The terms “upstream” and “downstream” are terms of art referring to relative positions along the transport path of the print media; points on the transport path move from upstream to downstream. In FIGS. 2, 3, 8, and 9 the media moves in the direction indicated by transport direction arrow 114. Where they are used, terms such as “first”, “second”, and so on, do not necessarily denote any ordinal or priority relation, but are simply used to more clearly distinguish one element from another.

Referring now to the schematic side view of FIG. 2, there is shown one example of an inkjet printing system that prints on a continuous web of print media. Printing system 100 includes a first printing module 102 and a second printing module 104, each of which includes lineheads 106, dryers 108, and a quality control sensor 110. Each linehead 106 typically includes multiple printheads (not shown) that apply ink or another liquid to the surface of the print media 112 that is adjacent to the printheads. For descriptive purposes only, the lineheads 106 are labeled a first linehead 106-1, a second linehead 106-2, a third linehead 106-3, and a fourth linehead 106-4. In the illustrated aspect of the present invention, each linehead 106-1, 106-2, 106-3, 106-4 applies a different colored ink to the surface of the print media 112 that is adjacent to the lineheads. By way of example only, linehead 106-1 applies cyan colored ink, linehead 106-2 magenta colored ink, linehead 106-3 yellow colored ink, and linehead 106-4 black colored ink.

The first printing module 102 and the second printing module 104 also include a web tension system that serves to physically move the print media 112 through the printing system 100 in the transport direction shown by the transport direction arrow 114 (left to right as shown in the figure). The print media 112 enters the first printing module 102 from a source roll (not shown) and the linehead(s) 106 of the first module applies ink to one side of the print media 112. As the print media 112 feeds into the second printing module 104, a turnover module 116 is adapted to invert or turn over the print media 112 so that the linehead(s) 106 of the second printing module 104 can apply ink to the other side of the print media 112. The print media 112 then exits the second printing module 104 and is collected by a print media receiving unit (not shown).

Although FIG. 2 depicts each printing module with four lineheads 106, three dryers 108, and one quality control sensor 110, aspects in accordance with the invention are not limited to this construction. A printing system can include any number of lineheads, any number of dryers, and any number of quality control sensors. The printing system can also include a number of other components, including, but not limited to, web cleaners, web steering components, and web tension sensors.

And although the printing system shown in FIG. 2 has the turnover module 116 disposed within the second printing modules 104, other printing systems can include the turnover module within the first printing module 102, or located physically between the two modules.

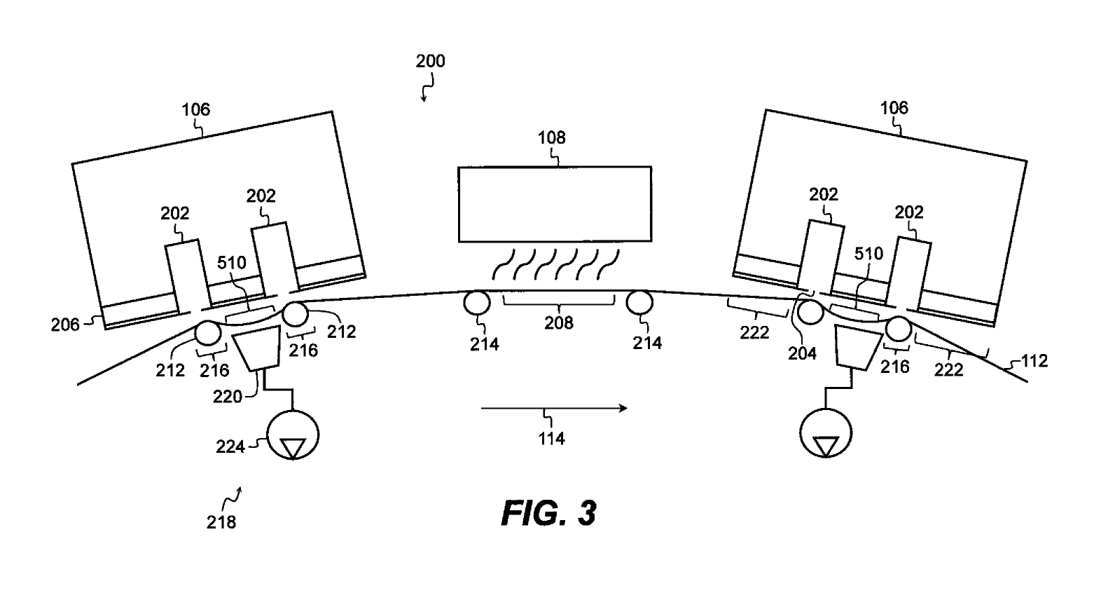

FIG. 3 depicts an example of an inkjet printing system according to an aspect of the invention. A print media 112 passes through the printing system 200, supported and guided by rollers 212, 214 that are located opposite a first side of the print media. The lineheads 106 and the dryers 108 of the printing system 200 are positioned opposite a first side of the print media 112. As the print media 112 is directed through the printing system 200, the lineheads 106, which typically include printheads 202, apply ink or another liquid to the first side of the print media 112 via the nozzle arrays 204 of the printheads 202. The printheads 202 within each linehead 106 are typically located and aligned by a support structure 206.

After the ink is jetted onto the print media 112, the print media 112 passes beneath the dryer 108, which applies air or heat 208 to the print media to dry the ink. The print media 112 is guided as it passes through the printing system 200 by rollers 212, 214. As the print media 112 is guided past the lineheads 106 and dryers 108, the rollers are arranged along an arc so that the print media is held in tension against each of the rollers 212, 214. To prevent the print media that is opposite the lineheads 106 from fluttering and contacting the linehead 106, the print media 112 is supported by rollers 212 that are aligned with each row of printheads 202.

The rows of printheads 202 each form a print zone 216 for a linehead 106. A vacuum assembly 218 having a vacuum manifold 220 is located between the rollers 212 located at the print zones 216 in the illustrated aspect according to the present invention. The vacuum manifold 220 is positioned opposite a second side of the print media 112 and is not aligned with the print zones 216 of a linehead 106. Instead, the vacuum manifold 220 is aligned with a non-print zone 222. The vacuum manifold 220 is positioned laterally adjacent to one or more print zones of a linehead. For example, in the illustrated aspect, the vacuum manifold 220 is laterally adjacent to and positioned between the print zones 216 of the linehead 106.

The vacuum assembly 218 also includes a vacuum source 224 that is fluidically coupled to the vacuum manifold 220. In some aspects of the present invention, a single vacuum source can be used to provide a vacuum force to multiple vacuum manifolds located along the transport path of the print media. Additionally, in some aspects of the present invention, the vacuum source can be located remotely from the printing system, such as a house vacuum system, with is connected to the one or more vacuum manifolds of the printing system by means of vacuum ducts.

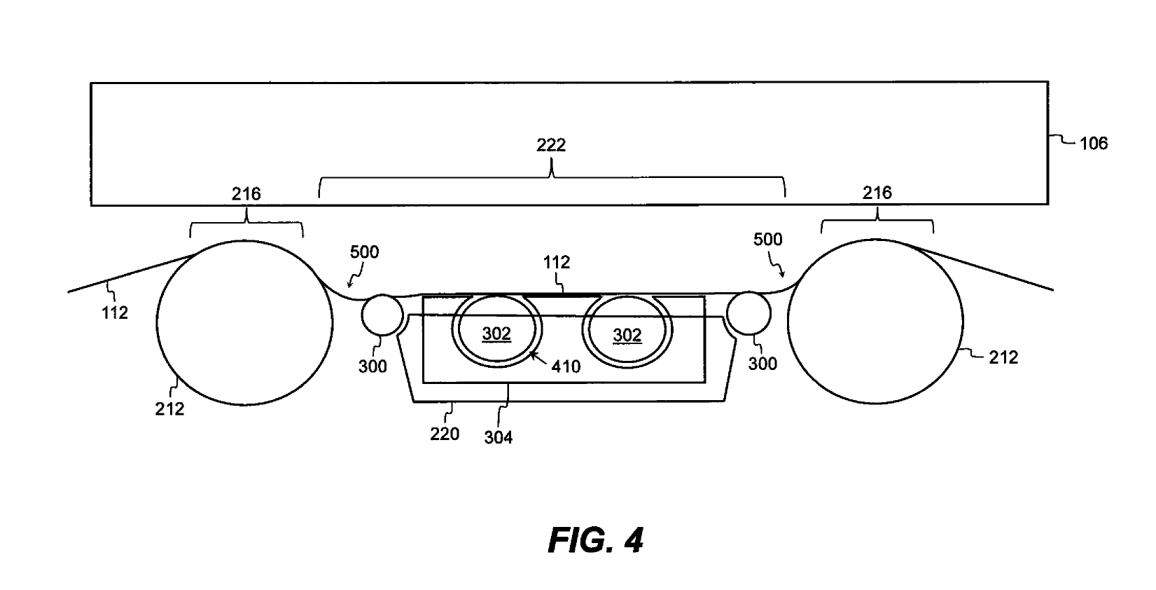

Referring now to FIG. 4, there is shown a more detailed side view of a portion of the printing system shown in FIG. 3. Sealing rollers 300 are positioned laterally adjacent to the vacuum manifold 220 and limit the flow of air into the vacuum manifold 220 along the leading and trailing edges of the vacuum manifold. The sealing rollers 300 are positioned in the non-print zone 222 and are recessed below the plane or level defined by the contact of the print media 112 with the top of rollers 212. The sealing rollers 300 support the print media 112 to create an air seal between the sealing rollers 300 and the print media 112. In one aspect of the present invention, the surface speed of the sealing rollers matches the speed of the print media because the sealing rollers 300 rotate as the print media moves over each sealing roller.

Guide surfaces 302 support the print media 112 in the opening of the vacuum manifold 220. Examples of guide surfaces 302 include, but are not limited to, rollers, non-rotating rods, or curved sheet metal surfaces. The guide surfaces 302 are also recessed below the plane or level defined by the contact of the print media 112 with the top of rollers 212. The print media 112 passes over the guide surfaces 302 when the print media is pulled down by a vacuum in the vacuum manifold. The guide surfaces 302 assist in stabilizing the print media 112 as the print media is pulled away from the linehead 106 by the vacuum. By stabilizing the print media 112 in the non-print zone 222, the guide surfaces 302 enable a more consistent print media path length between the print zones 216 of the linehead 106. This produces more consistent registration of the ink or liquid deposited on the print media 112 in the upstream print zone 216 with the ink or liquid deposited on the print media in the downstream print zone 216 of the linehead.

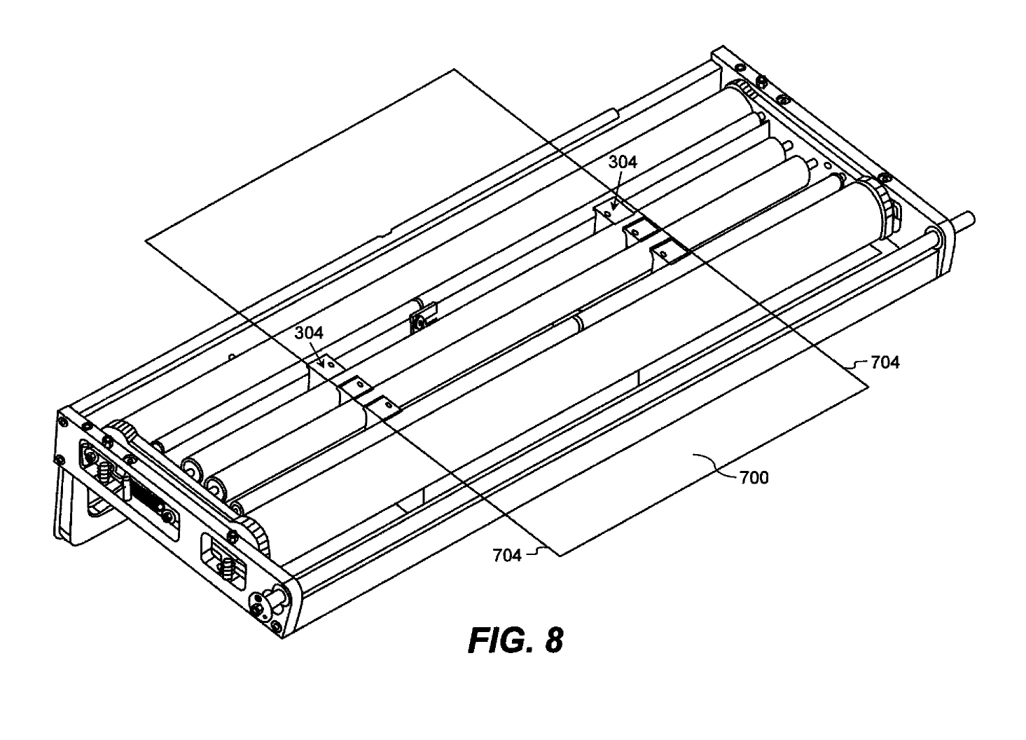

Edge seals 304 are disposed in the opening of the vacuum manifold 220, and are aligned with the edges of the print media as shown in FIG. 8. The edge seals 304 support the edges of the print media and limit the amount of air drawn into the vacuum manifold 220 from around the edges of the print media. The edge seal 304 are recessed below the plane or level defined by the contact of the print media 112 with the top of rollers 212. The edge seals 304 are positioned opposite a second side of the print media 112 and located within the non-print zone 222 of the linehead 106.

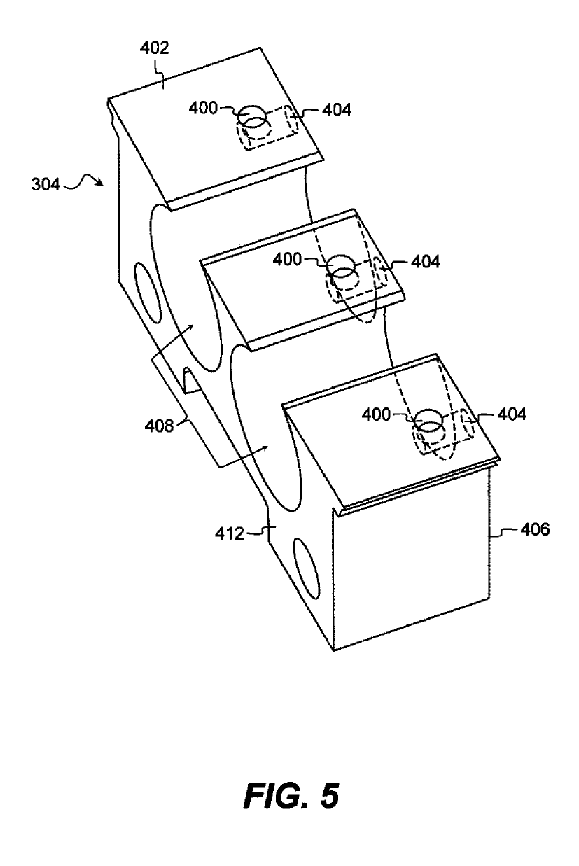

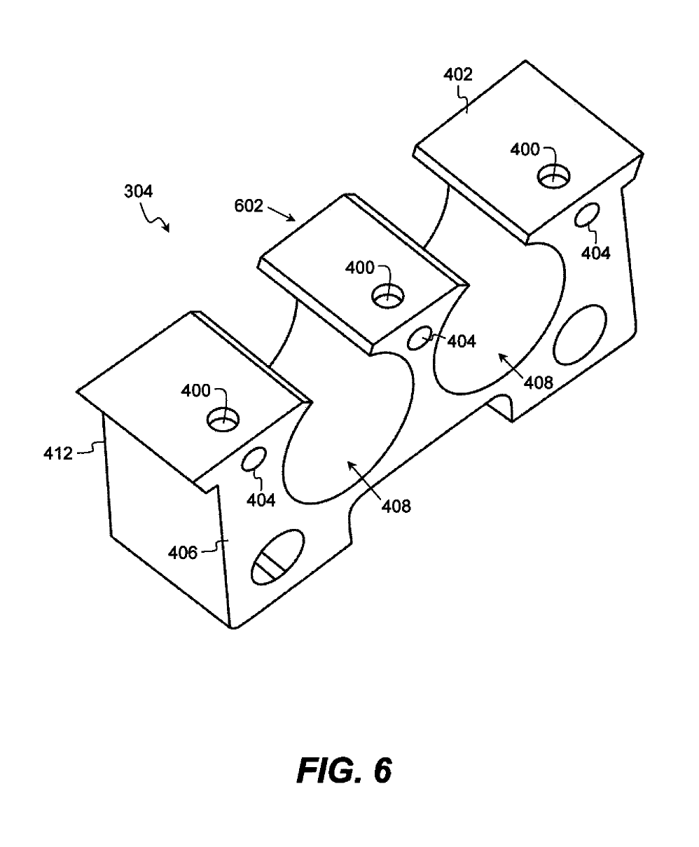

Edge seals 304 direct a vacuum to the edges of the print media in an aspect according to the invention. FIGS. 5 and 6 are perspective views of an example of edge seal 304 in an aspect according to the invention. Edge seals 304 include vacuum openings 400 formed in a print media contact surface 402, and side vacuum openings 404 formed in an inner surface 406. As will be described in more detail in conjunction with FIG. 8, a vacuum opening and a corresponding side vacuum opening form a tunnel or channel through the edge seal 304 that directs a vacuum produced by the vacuum manifold 220 to the print media contact surface 402.

Guide surface cutouts 408 are formed through the edge seal and have a shape that corresponds to the shape of the guide surfaces 302. In one aspect, the guide surface cutouts 408 provide sufficient clearance around the guide surfaces 302 to allow the guide surfaces to freely rotate as the print media 112 moves over the guide surfaces. While the guide surface cutouts 408 provide clearance around the guide surfaces 302, the length of the clearance gap 410 (see FIG. 4) between the guide surfaces and the guide surface cutouts provides sufficient flow impedance to limit the amount of air that can flow through the clearance gap to enter the vacuum manifold. The length of the clearance gap 410 corresponds to the distance between the inner surface 406 and the outer surface 412 of the edge seal 304. The guide surfaces 302 are disposed in the guide surface cutouts 408 such that the surface of the guide surfaces 302 that contacts the print media is horizontal or parallel with the plane defined by the contact of the print media with the print media contact surface 402.

The vacuum produced at vacuum openings 400 holds (without sticking) the print media to the print media contact surface 402. The print media contact surface 402 is preferably made of or coated with a slippery material in an aspect according to the invention. This allows the print media to more easily slide over the print media contact surface 402. One example of a slippery material is acetal copolymer 20% PET, distributed by DuPont™ under the trademark Delrin®.

The vacuum provided by the vacuum manifold acts on the print media, the vacuum force pulling the print media 112 towards the vacuum manifold 220 and the edge seals 304 bows the print media downward, away from the linehead 106 between the rollers and increases the wrap angle of the print media around the rollers 212 (see FIG. 4). The bowing of the print media 112 away from the linehead 106 provides additional clearance between the linehead and the print media, which can reduce the risk of flutes in the print media contacting the bottom face of the linehead. Holding the edges of the print media 112 against the print media contact surface 402 of the edge seals 304 reduces the amount of air leaking into the vacuum manifold between the edge seals 304 and the print media. By preventing or reducing the air flow between the edge seals and the print media, it reduces or prevents the edges of the print media from vibrating like a reed. As the vibration of the edges of the print media can adversely affect the quality of the images printed on the print media, use of the edge seals can improve print quality. Reducing the air leakage around the edges of the print media in this manner lowers the flow rate requirements of the vacuum source, which can lower the cost of the vacuum source. The reduced air leakage around the edges of the print media also helps to ensure a more uniform vacuum level all the way to the edges of the print media. It therefore helps to ensure a more uniform deflection of the print media toward the vacuum manifold across the width of the vacuum manifold.

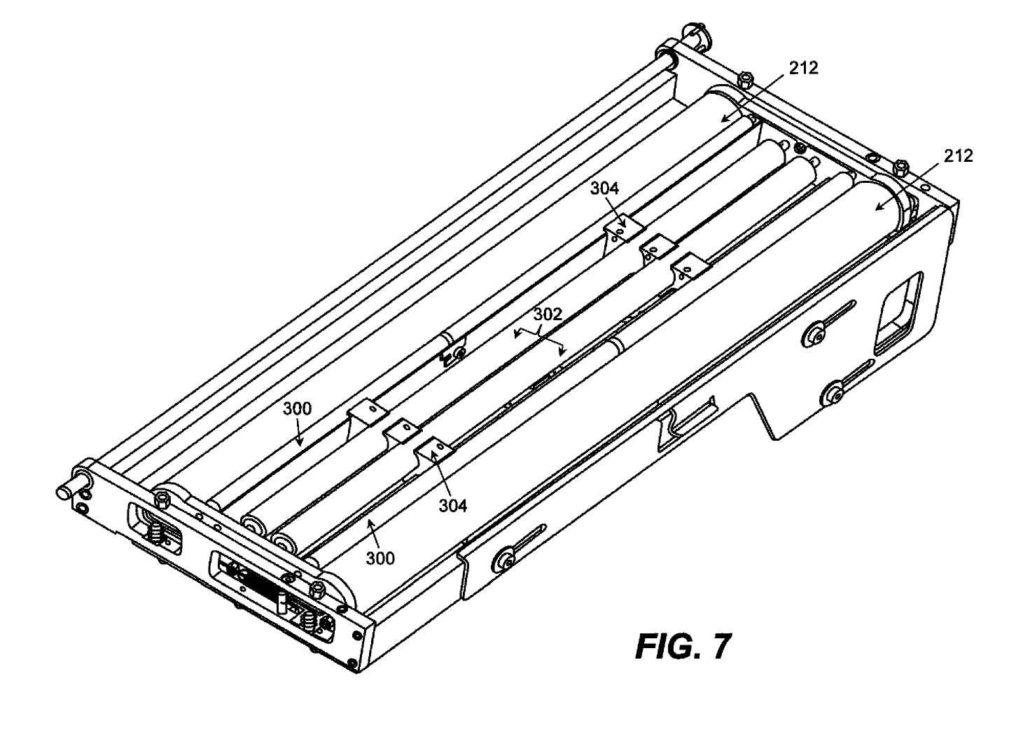

Referring now to FIGS. 7-8, there is shown an example layout of the rollers 212, sealing rollers 300, guide surfaces 302, and edge seals 304 in an aspect according to the invention. The edge seals 304 move or slide between the guide surfaces 302, allowing the locations of the edge seals 304 to be adjustable. This allows the locations of the edge seals 304 to be customized for various widths of print media 700. In one aspect, the outside edges of the edge seals 304 (see 602 in FIG. 6) are positioned to coincide with the edges 704 of the print media 700.

When a vacuum is produced by the vacuum manifold between the edge seals 304, the vacuum is distributed to the print media contact surface 402 of the edge seals 304 by the channel formed between the vacuum openings 400 and the side vacuum openings 404. The vacuum at print media contact surface 402 acts on the edges of the print media 112 and pulls the edges of the print media 112 against the print media contact surface 402. The amount of vacuum applied to the edges of the print media can be based on particular print job characteristics. The print job characteristics include, but are not limited to, a weight of the moving print media and a content density of the content to be printed on the moving print media.

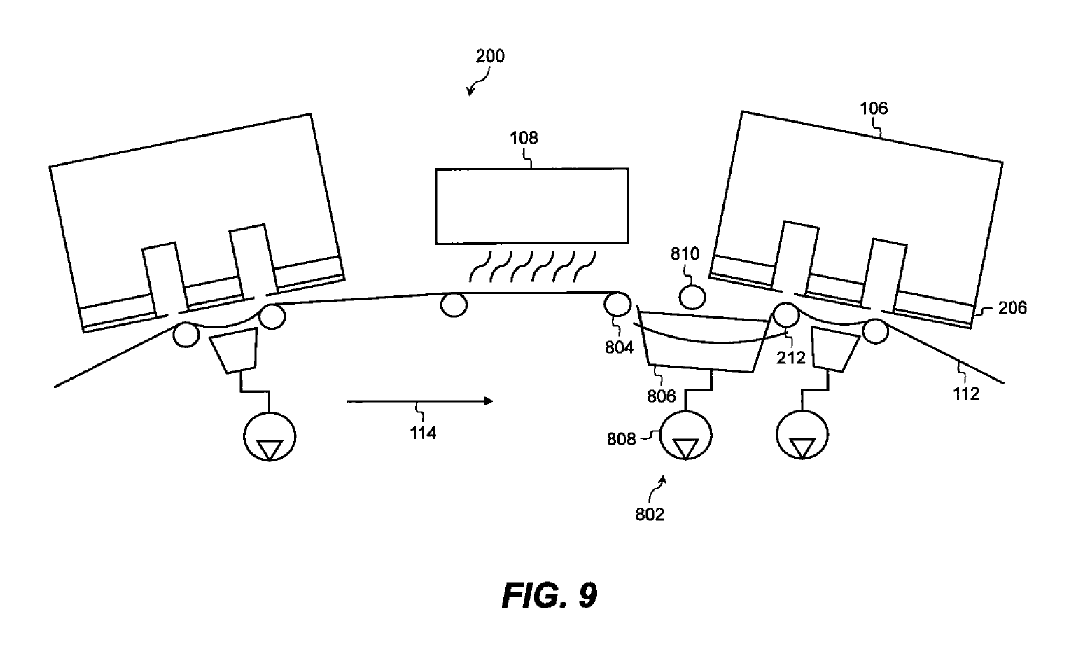

Although the invention has been described with reference to a vacuum assembly positioned opposite a linehead, aspects according to the invention are not limited to this construction. A vacuum assembly can be positioned at other locations in a printing system, and the sealing rollers, guide surfaces, and edge seals can be used to guide the print media as the print media passes over the vacuum assembly. FIG. 9 depicts an example of another printing system that includes a vacuum assembly. A vacuum manifold 806 is located between the upstream roller 212 of a linehead 106 and a roller 804 supporting the print media 112 at a position remote from the linehead, such as where the print media passes another component.

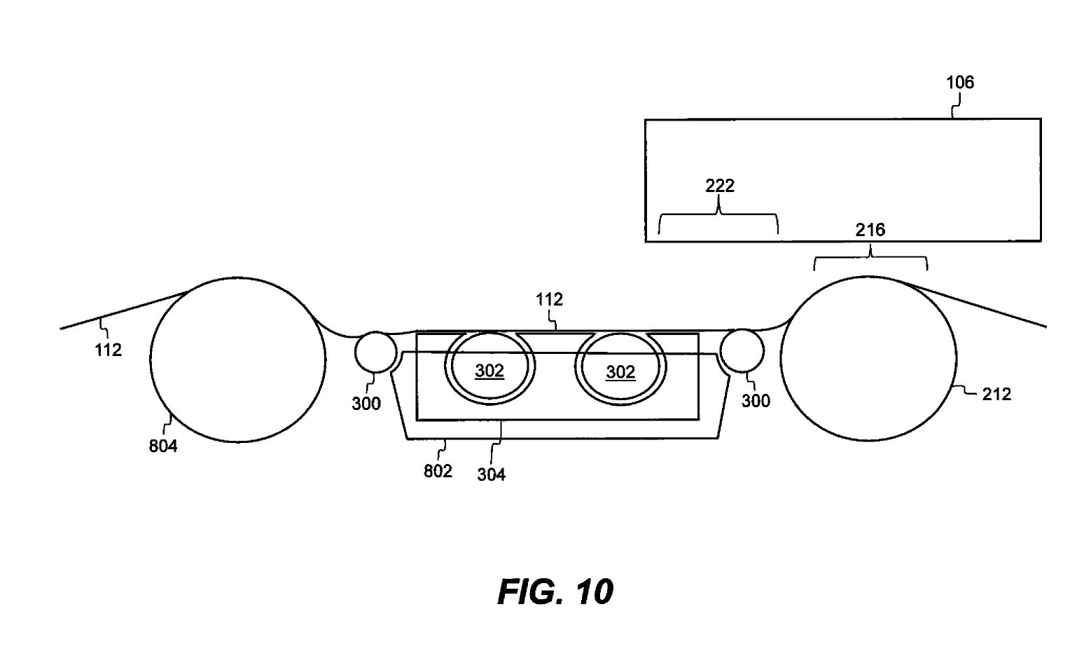

In the illustrated aspect according to the invention, the second vacuum assembly 802 is located between dryer 108 and the linehead 106. The vacuum produced by the second vacuum assembly 802 serves to deflect the print media 112 located between the rollers 804 and 212 away from the upstream edge of the linehead 106 or support structure 206. In the illustrated aspect, the second vacuum assembly 802 includes a vacuum source 808. As illustrated in FIG. 10, the vacuum manifold 806 can include sealing rollers 300, guide surfaces 302, and edge seals 304.

Another roller 810 can be located above the vacuum manifold 806 on the print side of the print media 112. When a vacuum is produced by the second vacuum assembly 802, the vacuum pulls the print media away from the roller 810. When the vacuum is deactivated, the print media contacts the roller 810. The roller 810 deflects the print media down relative to that path that the print media would have taken between the rollers 804 and 212. By so doing, the roller 810 locates a portion of the print media sufficiently close to the vacuum manifold 806 so that the vacuum can act effectively on the print media 112 to further deflect the print media.

According to an aspect of the invention, a printing system can include one or more vacuum assemblies each having a vacuum manifold disposed opposite a second side of the print media. Each vacuum manifold produces a vacuum proximate to the second side of the print media that pulls the print media towards the vacuum manifold as the print media is moved through the printing system. Edge seals can be included in the opening of each vacuum manifold that is proximate to the second side of the print media. The edge seals can include vacuum openings formed in a print media contact surface and side vacuum openings formed in a side surface. Each corresponding pair of vacuum and side vacuum openings forms a channel or tunnel through the edge seal. The vacuum produced by the vacuum manifold is distributed to the print media contact surface of each edge seal by each corresponding pair of vacuum and side vacuum openings. The vacuum at the print media contact surface holds the edges of the print media as the print media passes through the printing system.

The printing system can include one or more guide surfaces in the opening of each vacuum manifold. A guide surface cutout can be formed through an edge seal. Each guide surface cutout has a shape that corresponds to the shape of the guide surface or surfaces. One or more sealing rollers can be positioned laterally adjacent to a vacuum manifold. The sealing rollers can limit the flow of air into the vacuum manifold.

In another aspect of the present invention, the vacuum manifold can be positioned opposite a component in the printing system. By way of example only, the component can be a linehead that deposits a liquid or ink onto a first side of the print media. The linehead can include one or more print zones where the liquid or ink is deposited onto the first side of the print media. A vacuum manifold can be aligned with a non-print zone of the linehead and the vacuum produced proximate to the second side of the print media deflects the print media away from the linehead. Rollers can be disposed opposite the linehead and supporting the second side of the print media with at least one roller aligned with a respective print zone of the linehead.

In another aspect of the present invention, the vacuum manifold is positioned between components in the printing system. By way of example only, the components can be a linehead and a dryer.

Each vacuum assembly can include a vacuum source and the edge seals can slide or move, allowing the locations of the edge seals to be adjustable.

The invention has been described in detail with particular reference to certain preferred aspects thereof, but it will be understood that variations and modifications can be effected within the spirit and scope of the invention. And even though specific aspects of the invention have been described herein, it should be noted that the application is not limited to these aspects. In particular, any features described with respect to one aspect can also be used in other aspects, where compatible. And the features of the different aspects can be exchanged, where compatible.

### PARTS LIST

100 printing system
102 first printing module
104 second printing module
106 lineheads
108 dryers
110 quality control sensor
112 print media
114 transport direction arrow
116 turnover module
200 printing system
202 printheads
204 nozzle arrays
206 support structure
208 heat
212 rollers
214 rollers
216 print zone
218 vacuum assembly
220 vacuum manifold
222 non-print zone
224 vacuum source
300 sealing rollers
302 guide surfaces
304 edge seal
400 vacuum openings
402 print media contact surface
404 side vacuum openings
406 inner surface
408 guide surface cutouts
410 clearance gap
412 outer surface
700 print media
704 edges
802 second vacuum assembly
804 roller
806 vacuum manifold
808 vacuum source
810 roller

1. A printing system adapted to print on a print side of a print media, comprising:
one or more vacuum assemblies, each vacuum assembly having a vacuum manifold disposed opposite a non-print side of the print media;
each vacuum manifold having an opening proximate to the non-print side of the print media and produces a vacuum that pulls the print media towards the vacuum manifold as the print media is moved through the printing system; and
each vacuum manifold further including a plurality of edge seals, wherein each of the plurality of edge seals includes a channel for vacuum to be applied to the non-print side of the print media, the channel having at least one opening formed in a print media contact surface of the edge seal and at least one opening formed in a side surface of the edge seal and wherein the at least two openings are connected.

2. The printing system of claim 1 wherein the plurality of edge seals includes two edge seals located on opposite ends of each other, the locations of the two edge seals corresponding to the two opposite edges of the print media in a width-wise direction, the edge seals applying vacuum to hold the edges of the print media as the print media passes through the printing system.

3. The printing system of claim 1 wherein the size of the opening formed in the print media contact surface or the size of the opening formed in the side surface of the edge seal are adapted to be adjusted to control an amount of vacuum force applied to the print media.

4. The printing system of claim 1 wherein at least one of the edge seals is movable to vary the effective size of the vacuum manifold in response to the size of the print media.

5. The printing system of claim 1 further including at least one guide surface in the opening of each vacuum manifold and each edge seal having a guide surface cutout formed therein corresponding to the shape of the guide surface.

6. The printing system of claim 1 further including one or more sealing rollers positioned laterally adjacent to the vacuum manifold such that the sealing rollers limit the flow of air into the vacuum manifold.

7. The printing system of claim 1 further including a linehead positioned proximate the print side of the print media and opposite the vacuum manifold, the linehead adapted to deposit a liquid or ink onto the print side of the print media.

8. The printing system of claim 7, further including:
the linehead defining one or more print zones where the liquid or ink is deposited onto the print side of the print media; and
the vacuum manifold is positioned in alignment with a non-print zone of the linehead such that the vacuum produced proximate to the non-print side of the print media deflects the print media away from the linehead.

9. The printing system of claim 8 further including rollers disposed opposite the linehead and supporting the non-print side of the print media, wherein at least one roller is aligned with one of the print zones defined by the linehead.

10. The printing system of claim 1, further including a linehead and a dryer, wherein the vacuum manifold is positioned between the linehead and the dryer.

11. The printing system of claim 1, wherein each vacuum assembly includes a vacuum source.
